(19) United States
(12) Patent Application Publication
(10) Pub. No.: US 2025/0217666 A1
(43) Pub. Date: Jul. 3, 2025

(54) SYSTEM AND METHOD FOR IDENTIFYING A REQUEST OF A SERVICE IN CLOUD COMPUTING

(71) Applicant: R.C.Raven Cloud LTD, Tel Aviv-Yafo (IL)

(72) Inventors: Roi ABITBOUL, Mountain View, CA (US); Guy FRANCO, Tel Aviv (IL); Roland DANIELYAN, Yerevan (AM); Omer YAIR, Ramat Gan (IL)

(73) Assignee: R.C.Raven Cloud LTD, Tel Aviv-Yafo (IL)

(21) Appl. No.: 18/399,182

(22) Filed: Dec. 28, 2023

(51) Int. Cl. G06N 5/02; G06F 18/2325

(52) U.S. Cl. CPC G06N 5/02; G06F 18/2325

(57) ABSTRACT

A system and method for identifying a request of a service. The method includes generating vector embeddings for raw data of events using a machine learning model, wherein the machine learning model is trained to indicate semantic meaning of at least one event of the raw data of events; clustering, based on the vector embeddings, the at least one event of the raw data of events into a plurality of clusters, wherein a subset of the plurality of clusters includes relevant events in the data of events; and identifying a request as a sequence of events from the subset of the plurality of clusters.

### TECHNICAL FIELD

The present disclosure relates generally to cloud computing and, in particular, to systems and methods for identifying a request in cloud computing at runtime.

### BACKGROUND

Cloud computing refers to the delivery of various services over the internet. These services include storage, databases, servers, networking, software, analytics, intelligence, and more. Cloud computing offers faster innovation, flexible resources, and economies of scale.

Infrastructure as a Service (IaaS) is the most basic category of cloud computing services. With IaaS, the IT infrastructure—servers and virtual machines, storage, networks, operating systems—are rented on a pay-as-you-go basis. Cloud resources cost refers to the expenses associated with using various services and infrastructure provided by cloud computing vendors. These costs can vary significantly based on numerous factors. Such factors include the type of resource, and the usage of the resource, a region where the resource is deployed, and so on. The cost of cloud resources is a significant expense of companies providing SaaS over cloud infrastructure.

Traditional ways to reduce costs include, for example and without limitation, using saving plans, changing resource types to reserve from on-demand instances, and the like, and more, as some providers offer options to reserve instances for a longer-term, often at a reduced rate compared to on-demand pricing. Other approaches for reducing costs include resizing an instance (e.g., reducing compute power or memory of an instance). Yet another approach for reducing is a spot instance. A spot instance in cloud computing refers to a temporary, on-demand computing capacity that can be obtained at a significant discount compared to regular on-demand instances. Spot instances allow you to use spare computing capacity in a cloud provider's data center.

Though such techniques may offer some savings, these do not address the core problems of close compute power which include the bottleneck in execution of software. For example, an unoptimized piece of code may consume unnecessary computing power, thereby increasing the utilization of instances of cloud resources, which in return increases the overall cost. To this end, methods to optimize the bottlenecks in the workload (e.g., application, service, tasks, etc.) are desired for efficient processing, use of resources, and budget management.

It has been identified that one of the foremost challenges in optimizing bottlenecks and reducing compute power is the identification of relevant requests of the workload. Currently implemented cloud computing technology allows applications to run on multiple processors, which may also be temporary in nature. Thus, the triggering of an event or a start of a request is often unclear and may appear both implicitly and explicitly. Furthermore, identification of relevant requests with the correct sequential arrangement of the events that are associated with the relevant requests is even more challenging to determine with the distributed processing of applications (i.e., requests).

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for. The method comprises: generating vector embeddings for raw data of events using a machine learning model, wherein the machine learning model is trained to indicate semantic meaning of at least one event of the raw data of events; clustering, based on the vector embeddings, the at least one event of the raw data of events into a plurality of clusters, wherein a subset of the plurality of clusters includes relevant events in the data of events; and identifying a request as a sequence of events from the subset of the plurality of clusters.

Certain embodiments disclosed herein also include a non-transitory computer readable medium having stored thereon causing a processing circuitry to execute a process, the process comprising: generating vector embeddings for raw data of events using a machine learning model, wherein the machine learning model is trained to indicate semantic meaning of at least one event of the raw data of events; clustering, based on the vector embeddings, the at least one event of the raw data of events into a plurality of clusters, wherein a subset of the plurality of clusters includes relevant events in the data of events; and identifying a request as a sequence of events from the subset of the plurality of clusters.

Certain embodiments disclosed herein also include a system for identifying a request of a service. The system comprises: a processing circuitry; and a memory, the memory containing instructions that, when executed by the processing circuitry, configure the system to: generate vector embeddings for raw data of events using a machine learning model, wherein the machine learning model is trained to indicate semantic meaning of at least one event of the raw data of events; cluster, based on the vector embeddings, the at least one event of the raw data of events into a plurality of clusters, wherein a subset of the plurality of clusters includes relevant events in the data of events; and identify a request as a sequence of events from the subset of the plurality of clusters.

Certain embodiments disclosed herein include the method, non-transitory computer readable medium, or system noted above, further including or being configured to perform the following steps: sorting the relevant events based on a plurality of rules that are defined by additional information on each of the relevant events.

Certain embodiments disclosed herein include the method, non-transitory computer readable medium, or system noted above, wherein the additional information includes at least one of: timestamp, thread identifier (ID), micro-thread identifier (ID), processor identifier (ID), event type, and file descriptor.

Certain embodiments disclosed herein include the method, non-transitory computer readable medium, or system noted above, further including or being configured to perform the following steps: receiving raw data of events and call stacks that are collected during runtime of a workload, wherein raw data of events include additional information for each event in the raw data of events.

Certain embodiments disclosed herein include the method, non-transitory computer readable medium, or system noted above, wherein the raw data of events are collected at predefined intervals.

Certain embodiments disclosed herein include the method, non-transitory computer readable medium, or system noted above, wherein the plurality of clusters includes a first hierarchical level of clusters and at least one second hierarchical level of sub-clusters, wherein the subset of the plurality of clusters is a cluster of the first hierarchical level of clusters.

Certain embodiments disclosed herein include the method, non-transitory computer readable medium, or system noted above, wherein clustering is performed using at least one of: K-means clustering, Balanced Iterative Reducing and Clustering using Hierarchies (BIRCH), and Ordering Points To Identify the Clustering Structure (OPTICS) clustering.

Certain embodiments disclosed herein include the method, non-transitory computer readable medium, or system noted above, further including or being configured to perform the following steps: determining a start point and an end point using the sequence of events of the identified request; and determining a request performance.

Certain embodiments disclosed herein include the method, non-transitory computer readable medium, or system noted above, further including or being configured to perform the following steps: training the machine learning model based on a reconstruction loss, wherein the reconstruction loss determined by comparing an input sequence of a training dataset to an output sequence; and fine-tuning the trained machine learning model using a labeled training dataset to indicate the relevant events.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for determining optimization of a request according to an embodiment.

FIG. 3 is a flowchart illustrating a method for identifying a request according to an embodiment.

FIG. 4 is a flow diagram of a two-stage training of a transformer encoder of an identification system according to an embodiment.

FIG. 5 is a schematic diagram of an identification system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques for identifying a request of a service using machine learning models. The request is determined from events that are continuously monitored and collected (e.g., continuously, intermittently, or the like) during runtime of the service in a cloud environment. The disclosed embodiments utilize distinct patterns of events and/or sets of events (or sub-sequences of events) that are determined based on clustered outputs in order to identify relevant requests that may be optimized. The start and end events of the request are determined for analysis of request performance that indicate optimized utilization of cloud computing resources.

More specifically, the disclosed embodiments provide identification of requests through accurate and efficient clustering of monitored events. The sub-sequences of events are clustered based on, for example, processor identifier (ID), thread identifier (ID), micro-thread identifier (ID), timestamp, event type, file descriptor, and the like, and any combination thereof, that may be utilized to determine distinct patterns of a request. It has been identified that the temporal and distributed nature of the current cloud computing environments results requests to be performed in multiple instances or resources. Thus, identification of requests, and its start and end events, is a challenge without prior information. However, the embodiments disclosed herein utilize effective encoding and clustering of events and sets of events to identify the start and end of requests that are observed during runtime.

The embodiments disclosed herein apply trained machine learning models to accurately and consistently encode and cluster sequences and sub-sequences of events. Such encoded vector embeddings incorporate position, order, relation, and the like between observed events as vector representations, thereby providing insights of continuity and connectivity of the events. In an embodiment, trained transformer encoder may be employed for improved semantic analysis of events in the monitored events.

According to the disclosed embodiments, a two-stage, semi-supervised learning is performed to improve accuracy and efficiency in training as well as actual identification of the request. More particularly, the two-stage training is implemented to train a transformer encoder component to generate accurate embeddings of the received events. In an embodiment, the first stage training utilizes a transformer decoder to generate improved vector embeddings of the received raw data of events (e.g., monitored and randomly collected events at runtime). In a further embodiment, the second stage training utilizes a classifier, in place of the transformer decoder, to fine-tune the transformer encoder for determination of relevant events. It should be appreciated that the two-stage training enables accurate determination of relevant and irrelevant events with respect to request performance optimization. Such accurate determination of relevant event improves accuracy in identifying requests from events collected during runtime, and further conserved computing resources by analyzing relevant events and requests (and not the irrelevant events and requests) for analysis and optimization.

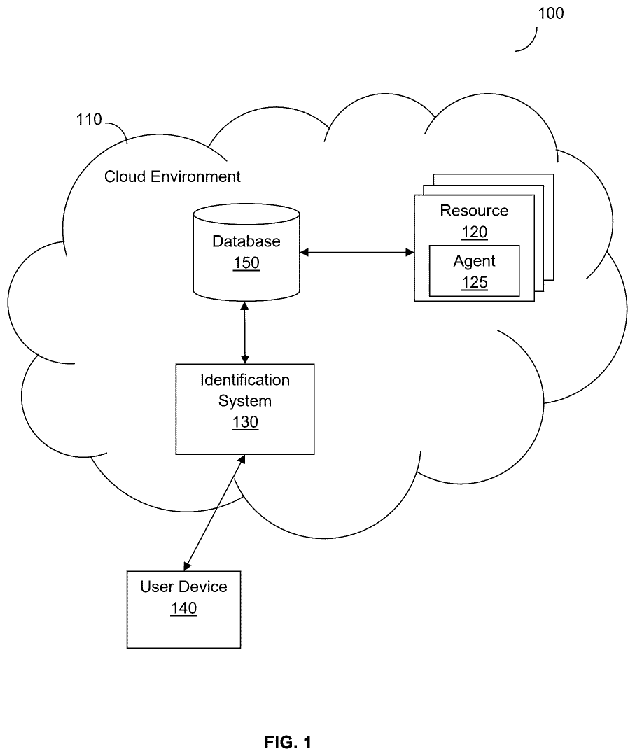

FIG. 1 shows an example cloud diagram 100 utilized to describe the various disclosed embodiments. In the example cloud diagram 100, cloud resources 120 (hereinafter referred to individually as a resource 120 and collectively as resources 120, merely for simplicity purposes), agents 125 (hereinafter referred to individually as an agent 125 and collectively as agents 125, merely for simplicity purposes), an identification system 130, and a database 150 communicates within a cloud environment 110. Moreover, the example cloud diagram 100 includes a user device 140 that communicates with the identification system 130 over a network. A plurality of cloud resources 120 and corresponding agents 125 may be deployed in the cloud environment.

The network may include, but not limited to, a wireless, cellular or wired network, a local area network (LAN), a wide area network (WAN), a metro area network (MAN), the Internet, the worldwide web (WWW), similar networks, and any combination thereof. In some embodiments, the identification system 130 may be installed outside of the cloud environment 110 and communicated via the network.

The cloud environment 110 may be, but is not limited to, a public cloud, a private cloud, or a hybrid cloud. A public cloud is owned and operated by a third-party service provider that delivers computing resources for use over the internet, whereas a private cloud is cloud computing resources that are exclusively used by a single business or an organization. A hybrid cloud combines the public cloud and the private cloud that allows data and application sharing between both types of computing resources. Some examples of a cloud environment 110 may include, and without limitation, Amazon Web Services (AWS), Microsoft® Azure, Google Cloud Platform (GCP), and the like, which may also be referred to as cloud providers.

The user device (UD) 140 may be, but is not limited to, a personal computer, a laptop, a tablet computer, a smartphone, a wearable computing device, or any other device capable of receiving and displaying notifications. The user device 140 may receive analysis reports generated at the identification system 130 via a graphical user interface (GUI) such as, but not limited to, a dashboard. The analysis report describes performances of requests, event performances, and resource utilizations for executing the workloads including, for example, but not limited to, monitored services, bottleneck events and/or functions, one or more optimization opportunities, performance degradation, cost savings upon optimization, and more, and any combination thereof.

The cloud resources 120 are virtual components or capabilities that are provided by the cloud environment 110 to perform workloads. The resources may be rapidly provisioned and released with minimal management effect and are accessible over the internet. The cloud resource 120 may be configured to perform requests of one or more workloads (e.g., service, application, etc.) at instances that are used on-demand based on the need for processing workloads. Simultaneous processing of workloads and requests is continuously performed in the cloud resource 120, which may cause interdependencies in request performances. Moreover, events of the request may be performed across multiple resources at different sequences. It should be noted that efficient usage of instances and resources 120 as a whole is desired to reduce cost and further to conserve computing resources at, for example, the cloud resources 120.

Each of the cloud resources 120 is configured with an agent 125 (which may be realized as a piece of code stored in a memory and executed over a process of the cloud resource 120) to monitor the workload at an instance of the resource 120. The agent 125 is configured to collect raw data on the events, for example, but not limited to, opening a file, sending over a network, sending data over a socket, time update, and the like, and corresponding call stacks, in executing the service (or application). The call stack is a data structure that keeps track of active events (or functions) within the workload. A portion of a request (or sequence of events) containing more than one event may be referred to as a set of events or a sub-sequence of events. In an embodiment, the collected raw data of events may be stored at the database 150. In a further embodiment, the collected raw data of events may be directly received and analyzed at the identification system 130.

In an embodiment, the agent 125 is a code that runs in the kernel of the operating system and provides the collected data to the identification system 130. In a further embodiment, the agent 125 may run in a user mode by, for example, but not limited to, dynamically instrumenting the application code, using specific operation system (OS) functionalities (e.g., ptrace, etc.), or the like, and more. In an embodiment, the collected data is stored in a memory at the resource 120.

The identification system 130 is a component, device, or the like, in the cloud environment 110 that processes raw data and call stacks to identify requests of an application (or service). The identification system 130 includes artificial intelligence (AI) processors such as, but not limited to, graphics processing unit (GPU), tensor processing unit (TPU), and the like. The raw data of events includes a plurality of events that are randomly collected over a predefined time period, for example, 1 hour. The identification system 130 applies trained machine learning models to accurately encode and cluster raw data of events and determine sequence of events that represent the request. The identification system 130 is further configured to analyze request performances for assessing effective utilization of cloud resources.

The identification system 130 is configured to analyze raw data of events that is monitored and collected via the agent 125 during regular runtime. In such a scenario, events are received randomly without information about the sequence of events in association with a particular socket, processor, or the like. The raw data of events include additional information such as, but not limited to, system calls, input/output (I/O) operations, CPU performance counter events, memory operations, synchronization operation, and the like.

According to the disclosed embodiments, the identification system 130 includes one or more machine learning models that are utilized to identify the request from the raw data of events. The one or more machine learning models may include, for example, but not limited to, a transformer model with a transformer encoder component, a transformer decoder component, a classifier, and the like, and more. A trained transformer encoder component is a logic component of the identification system that is configured to generate vector embeddings of the input raw data of events. The vector embeddings are vector representations of the input raw data indicating the semantic sequences between the events that are performed for execution of requests or workloads for services. In an embodiment, the transformer encoder component is trained using a two-stage, semi-supervised machine learning process to accurately determine pattern and/or sequence of events that define at least one request (and/or portions of at least one request) of the workload. In some implementations, the transformer encoder component may include a positional encoding algorithm to encode positional information of each of the events with respect to one another.

The identification system 130 further configured to analyze performance of events within the identified request. A contribution of at least one event on the performance of the request may be determined to identify one or more events that may be optimized to improve the request performance as a whole. It should be noted that the request identified as described herein is a relevant request (and events) that may be modified to improve and optimize utilization of cloud computing resources. The terms event and functions are used interchangeably herewith to describe the function that executes the event. In an embodiment, such identified event, that is unoptimized, may be determined as a bottleneck event and an optimization opportunity. It should be noted that such optimization to improve request performances allows more efficient utilization of instances and its resources 120, which further reduces computational power and costs for processing workloads at resources 120.

In an embodiment, the identification system 130 is configured to analyze request data that is monitored and collected via the agent 125 during regular runtime. In such a scenario, no intentional modification of the event or request is performed for analysis and instead, the inherent delays caused at one or more functions due to native randomness of the system are utilized to identify functions that effect request performances. The identification system 130 is further configured to perform a statistical analysis of event performances analyzed for a wide range of request scenarios. In an embodiment, a function that causes lower request performance (i.e., longer request latency, lower request throughput, etc.) is identified as an optimization opportunity or a bottleneck function. The inherent delays that cause delay in a certain event or function is, for example, but not limited to, context switching, network delays, and the like. The identification system 130 may receive request data for multiple request occurrences that varies in request type, delayed event type, and the like, and more, which may be concurrently analyzed.

In an embodiment, the identification system 130 is configured with or is communicatively connected to a database (not shown). The database stores performance data (e.g., latency, throughput, and the like) for at least one request as well as corresponding event contributions and event performances. Statistical analysis of the event performance data may be performed to determine, for example, and without limitation, median, average, maximum, minimum, range, and the like. In an example embodiment, the statistical analysis may be performed for event contributions collected within a predetermined time period. As an example, the event performance may be determined for event contributions determined within 5 minutes. In some embodiments, the statistically analyzed performance data may be stored as predetermined performance data. It should be noted that the predetermined performance data may be updated with continued analysis of requests and stored at the database (not shown).

The database 150 is configured to store raw data of events monitored and collected from the resources 120. The events may be stored, as received, including various raw data for example, but not limited to, event type, timestamp, processor ID, thread ID, micro-thread ID, and the like, and any combination thereof. The processor ID, thread ID, and the micro-thread ID are distinct identifiers that describe the processor (or resource) that processes the event, the thread in which the event belongs to, a micro-thread in which the event belongs to, respectively, of each event. The thread and micro-thread refer to a set of instructions or events that are performed for execution of the request. Some examples of micro-threads include, without limitation, goroutines in Golang, coroutines in C++/Kotlin/Java, and the like, and more. In such examples, the thread ID may be an identifier of a Goroutine, Coroutine, or like functions, and the micro-thread IDs may be addresses of the micro-thread in memory or any other value that uniquely identifies a single instance of a micro-thread.

The database 150 may intermittently receive the raw data of events at predetermined time intervals for a predefined time period for storage. In other implementations, the database 150 may selectively send portions of the stored raw data of events to the identification system 130. In an embodiment, a sequence of events (i.e., request including one or more events) that is identified at the identification system 130 may be returned to the database 150 and stored therein. In an example embodiment, the sequence of events may be stored as a request map identifying events arranged in one or more threads without specific identification (e.g., processor ID, thread ID, micro-thread ID, etc.) of the events. In some implementations, the database 150 may be a component of the identification system 130.

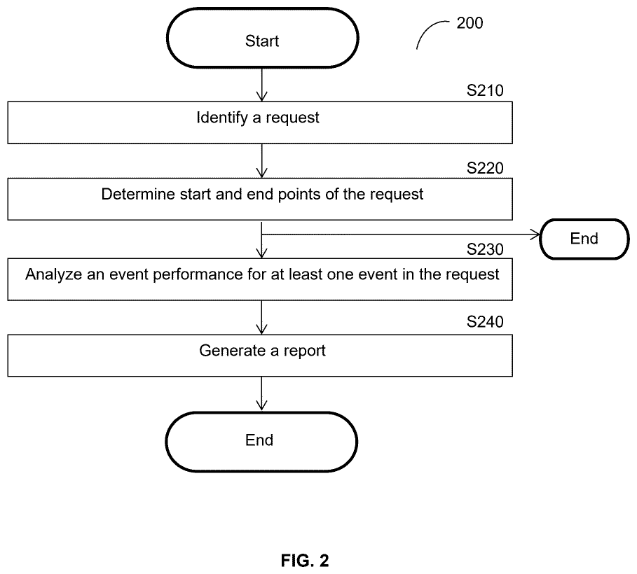

FIG. 2 is an example flowchart 200 illustrating a method for determining performance and optimization of a request according to an embodiment. The method described herein may be performed at the identification system 130, FIG. 1, which may be configured in or outside a cloud environment 110, FIG. 1. It should be noted that the method is described with respect to a single request for simplicity and without limiting the scope of the disclosed embodiments. The method may be performed for a plurality of requests simultaneously, consecutively, or the like.

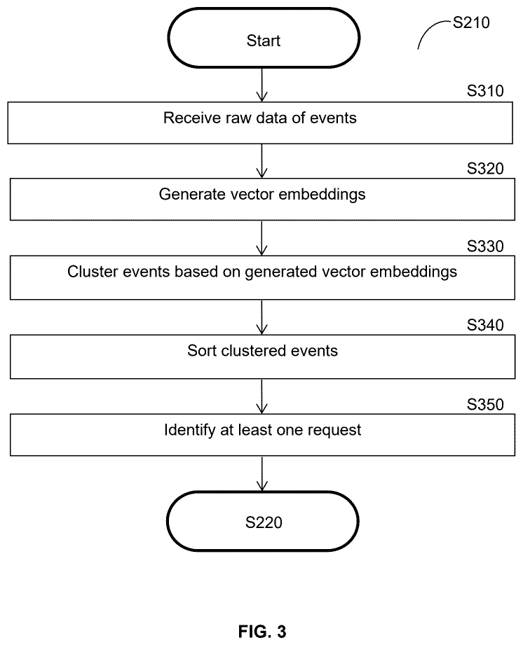

At S210, a request is identified. The request for a workload (e.g., task, application, service, etc.) includes one or more threads; each thread may include a sequence of events to perform the workload. The request may be identified by an event pattern that is monitored by the agent (e.g., the agent 125, FIG. 1) and identified by the identification system (e.g., the identification system 130, FIG. 1). The events that occur during runtime of the workload are received from one or more resources (e.g., the resources 120, FIG. 1) as raw data of events that may be randomly collected without apparent order or association with requests. To this end, the received raw data of events are processed using at least one algorithm, such as a machine learning algorithm, to determine sequences of events or event patterns that indicate the requests. It should be noted that the method described herein allows identification of relevant requests that may be optimized for improved request performance and thus, the overall utilization of the cloud resources. Further analysis to determine optimization and identify bottlenecks in the request performance is determined for relevant requests thereby conserving computing resources and power. In an embodiment, the identification of a request is described further below with respect to FIG. 3.

At S220, start and end points of the request is determined. The sequence of events that represent the at least one identified request and respective call stacks are received and utilized to determine the start and end points of the identified requests as well as to measure the latency of the request. The latency is the time taken to process the request from the start point and the end point. The raw data and the call stacks are received from the agent (e.g., the agent 125, FIG. 1). The raw data includes, for example, but not limited to, system calls, input/output (I/O) operations, CPU performance counter events, memory operations, synchronization operation, and the like of functions (events) executed in the request. The call stacks are associated with the request and define the active functions at different times within the request.

In an embodiment, upon determination that the request latency is greater than a predefined threshold percentile, the operation continues to S230. Otherwise, the operation ends for the request. In an example embodiment, the predefined threshold percentile is 75th, which includes requests with request latencies greater than a predetermined median latency for the request (i.e., slower processing of request). In an embodiment, a request latency below the predefined threshold percentile is considered as having acceptable performance and further optimization may not be desired. In an embodiment, a throughput (i.e., number of output of requests per time) of consecutive occurrences of the request over a predefined time period may be utilized to compare against the predefined threshold percentile. In some implementations, aggregated request latency and/or throughput determined over time is utilized to determine whether the request performance is acceptable or needs further optimization.

The steps of S210 to S220 are performed for each request that is identified through monitoring of events during runtime at the cloud environment. The latency and throughput measured for requests (i.e., request performances) are aggregated to determine various threshold values, for example, a distribution, median, average, minimum, maximum, and the like, of the request performances. In an embodiment, such various threshold values may be stored in a database of the identification system (e.g., the identification system 130, FIG. 1).

At S230, an event performance for an event in the request is analyzed. The event performance is determined for each event in the request through statistical analysis of event contributions in multiple occurrences of the request. Such event performance indicates the effect of the corresponding event on the request performance such as, but not limited to, latency, throughput, and the like. To this end, the event performance suggests an optimization opportunity of the request and may further identify a bottleneck event (or function) of the request. The optimization opportunity indicates portions of the request (i.e., events or functions) that may be modified to improve performance of the request, thereby improving the utilization of computing resources of, for example, the cloud computing platform.

In an embodiment, inherent delays such as, but not limited to, context switching, network delay, and the like, and any combination thereof, in the resources when handling the workload are employed to calculate virtual speed up of certain functions. It should be noted that the inherent delays occur during routine runtimes of the workload and/or request. To this end, additional involvement to create a slowdown of certain functions, and thus events, is eliminated.

In an embodiment, the aggregated event contributions from multiple request occurrences are utilized to determine event performance of a specific event. A statistical analysis is performed on the aggregated data to accurately account for different runtime conditions including, for example, interdependencies between functions, active functions, and the like, and more. The performances of each event may be aggregated for a plurality of requests that are processed over a predefined period of time. In an example embodiment, an event is determined to be underperforming and a bottleneck upon determination that the performance data is beyond a predefined range. As an example, an event is determined to be underperforming when the statistically determined duration of the event is above the predefined 75th percentile of performance data collected for the specific event. In another example, the event is determined to be a bottle when the event is above the 75th percentile range, 75th percentile or greater, based on its performance. In a further example embodiment, the event is determined to be optimized (or acceptable) upon determination that the performance data is below predefined threshold. As an example, an event is identified to be optimized when the performance data (or duration) is below a 25th percentile of the specific event's performance data.

At S240, a report is generated. The report describes the results of analyzing an event performance for the at least one event and may include, for example, but not limited to, monitored workload, instance, resources, and the like, bottleneck event and/or functions, degree of performance degradation, optimization opportunity, suggestions for optimization, cost saving upon optimization, and more, and any combination thereof. The optimization of the request and/or bottleneck event may include, without limitation, parallelizing the event, changing or optimizing data structure that the function utilizes, caching the results, and the like, and any combination thereof. In some embodiments, suggestions for optimization may include adding additional computing resources to support the execution of the function. In some implementations, the report may be generated upon identifying an optimization opportunity based on the event performance, for example, that is below a predetermined threshold value. The report may be caused to be displayed via a user device (e.g., the user device 140, FIG. 1). In an embodiment, the report may be generated periodically at predetermined time intervals preset by, for example, a user. It should be noted that modification and/or optimization of the identified optimization opportunity enables improved performance and utilization of cloud resources.

FIG. 3 is an example flowchart S210 illustrating a method for identifying at least one request according to an embodiment. The method described herein may be performed at the identification system 130, FIG. 1, which may be configured in or outside a cloud environment 110, FIG. 1. In an embodiment, at least one machine learning model, such as a transformer model, a clustering model, and the like, may be utilized.

At S310, raw data of events are received. The raw data of events and corresponding call stacks are collected from the one or more resources (e.g., the resources 120, FIG. 1) during runtime. The raw data may include, for example, but not limited to, system calls, input/output (I/O) operations, CPU performance counter events, memory operations, synchronization operation, and the like of the events. Moreover, the raw data includes additional information such as, timestamp, thread identifier (ID), processor identifier (ID), micro-thread ID, event type, and the like, and any combination thereof for each of the events. The call stacks are associated with events and/or requests and define active events at different times. The raw data of events is a log of events that may be collected for a predefined time period (e.g., 1 hour, 2 hours, etc.) at predefined intervals. The events are collected intermittently rather than continuously to reduce computing and networking burden. It should be noted that the events such as, but not limited to, time update, socket opening, socket closing, sending data over the network, opening a file, and the like, are monitored during runtime and thus, are collected without specification to a request, portions of a request, or the like. That is, the raw data of events is a log of events that are randomly observed regardless of request, thread, and the like and that are not sequentially ordered as identifiable requests. As an example, when there are two requests being concurrently run, the events of the two requests are intermixed together in a single list that are chronologically ordered based on their corresponding timestamp.

The raw data of events may be received from a database (e.g., the database 150, FIG. 1) that stores monitored events at one or more resources (e.g., the resources 120, FIG. 1). In some implementations, the raw data of events may be directly received from the one or more resources. In an embodiment, the raw data of events may be received intermittently based on an identification policy. The intermittent receival of raw data of events may be the same or different from the predetermined time interval in which the database and/or the identification system receives raw data from the resources.

At S320, vector embeddings are generated of the received raw data. The vector embeddings are vector representations of the raw data of events that may include multiple rows of multi-dimensional vectors. The vector embeddings describe raw data of events (i.e., random sequence of events) with semantic meaning including, for example, but not limited to, position, relation, and the like, between the events. In an example embodiment, a vector embedding for each event is represented per row, together with other respective additional information such as, but not limited to, timestamp, processor ID, thread ID, micro-thread ID, and the like, and any combination thereof. In other implementations, the vector embeddings may represent possible combinations of events. For example, a vector embedding may represent 4-5 events.

Moreover, the vector embeddings are generated to indicate whether an event of the raw data is “noise” (irrelevant) or “not noise” (relevant). Here, noise refers to events that are associated with requests that are not applicable for request performance optimization. The events in such requests are determined to be irrelevant and defined as noises. As an example, when events such as time update, file opening, and socket connection are observed in the raw data, events of the socket connection that may be optimized for request performance optimization may be described as “not noise” and events of time update and file opening may be described as “noise.” It should be noted that many event logs are irrelevant and may not be optimized for improved performance and resource utilization. To this end, identification of irrelevant and relevant events allows focused analysis on portions of the raw data that are identified. The generated vector embeddings are utilized to create an embedding space that distributes vector embeddings according to their semantic closeness and may be expanded with usage.

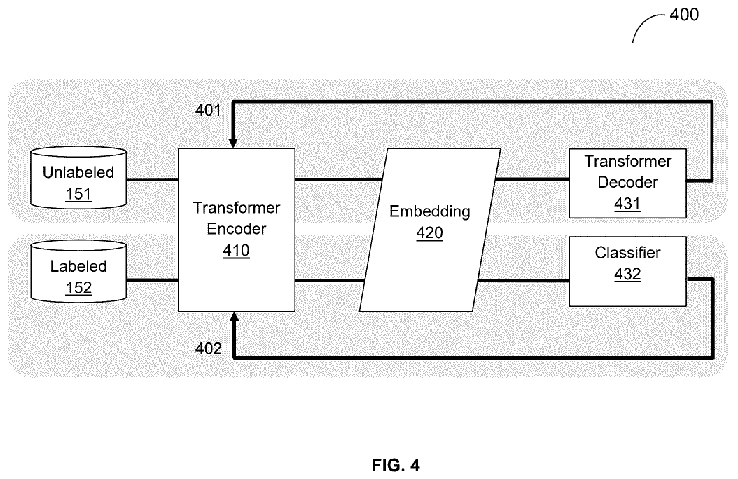

At least a trained machine learning model, or a component thereof is applied to the received raw data to generate the vector embeddings. In an embodiment, a transformer encoder component may be applied. In a further embodiment, encoding using the transformer encoder includes positional encoding to analyze position (or location) of events within the randomly collected events in the raw data in order to capture sequential arrangement of events. The trained transformer encoder component analyzes semantic relationships between the events that are dispersed in the raw data of events that are collected during runtime. Semantically similar events, for example, based on position, relation, type, and the like, are positioned closer together as represented by their vector embeddings. It should be noted that the generated vector embeddings provide accurate description of the network events observed during runtime, which may be distributed amongst multiple instances, resources, requests, and the like, without prior knowledge. In an embodiment, the transformer encoder component is trained as described further below with respect to FIG. 4.

At S330, the event sub-sequences are clustered. Similar events are clustered based on the generated vector embeddings. The events may be added to existing clusters and/or to newly created clusters when a close cluster has not been previously created. The cluster of events includes events that are similar or close with respect to, for example, event type, position, and the like, and any combination thereof, which are described in the generated vector embeddings. The generated clusters may be given a unique identifier, for example a cluster number, to define the events (or sub-sequences) included in the cluster. The cluster number may be associated with the event as part of the additional information (e.g., thread ID, micro-thread ID, processor ID, etc.) of the event. The clusters and sub-clusters include events that are sufficiently similar and thus, may include same event types in the same request. In addition, a subset of clusters includes the relevant (not noise) events and another subset of clusters includes the irrelevant events (noise). The subset of clusters includes at least one cluster of events.

In an embodiment, a hierarchical clustering algorithm is applied to generate clusters and sub-clusters that are grouped based on their similarities. The hierarchical clustering may include at least two hierarchical levels with a first level including two clusters defined as noise and not noise. The cluster identified as relevant includes events and sequences of events (or requests) of a workload. As noted above, the events clustered as noise are events of a request that is not applicable for performance optimization. The events and set (or group) of events in the noise cluster may be disregarded and not utilized in the following steps. It should be noted that the first level clustering of events in the raw data as noise and not noise filters out a large number of irrelevant events to conserve computing resources such as memory, power, and the like. A second level includes at least one sub-cluster that is nested within a cluster of the first hierarchical level.

In an example embodiment, the hierarchical clustering may include three hierarchical levels that each include one or more clusters. As an example, a first level is noise or not noise, a second level has cluster including one or more events, and third level clusters that contain individual events. The hierarchical clustering of events allows nested clustering of events with lower level clusters (e.g., first level clusters) nesting one or more next level clusters (e.g., second level clusters) based on semantic similarity down to identical events. In some implementations, one or more clustering algorithms such as, but not limited to, K-means clustering, Balanced Iterative Reducing and Clustering using Hierarchies (BIRCH), Ordering Points To Identify the Clustering Structure (OPTICS) clustering, and the like, or any combination thereof may be utilized to cluster the events.

The clustering algorithm may be updated for improved clustering of events by, for example, semi-supervised learning, supervised learning, and the like. The clusters of events and/or set of events (i.e., a sequence of one or more events) may be utilized in effectively update the clustering algorithm by bulk-labeling or moving the clusters. As an example, when a cluster including a first event has been identified to be relevant to request performance optimization, the whole cluster as well as its subcluster, if any, may be detached and clustered within the first cluster level of not noise. Such update or modification of the clustering algorithm may be performed intermittently, for example and without limitation, after applying the models for a few days, a few weeks, and the like. In an example embodiment, a person associated with the identification system (e.g., the identification system 130, FIG. 1) may audit the events in the clusters. In a further example embodiment, the person may inspect clusters via the user device (e.g., the user device 140, FIG. 1).

At S340, clustered events are sorted. The relationships between the clusters and subclusters are utilized to determine sequence of events. The additional information such as, but not limited to, timestamp, thread ID, micro-thread ID, and the like, as well as semantic relationship determined for the events are utilized according to a plurality of rules to sort events within the cluster as well as between nested clusters in order to sequentially arrange the events. For example, all events on, for example, socket connection may be arranged in the order of their associated timestamp. Then, the subsequent event of sending data is determined based on the timestamp, identical thread ID, and the like. The plurality of rules defined by weights, scores, rankings, and the like of, for example, additional information, vector embeddings, cluster, and the like, determines the sub-sequences of events of at least one request. As an example, events in one cluster may be sorted chronologically based on the timestamp. A large time gap above a predefined threshold time gap may be utilized to determine two separate sub-sequences, one before the large time gap and one after the large time gap. The predefined threshold time gap may be, for example, 0.1 nanoseconds. In the example scenario, other additional information, for example the thread ID, may be applied based on the plurality of rules to accurately sort the clustered events in order to determine the sub-sequences and/or sequences of events of the requests.

At S350, at least one request is identified. The at least one request is identified based on the arrangement of events determined by clustering. The request includes one or more threads that each include at least one event as determined through sorting. The identified at least one request is a relevant request for which performance optimization may be performed. Requests that are irrelevant (i.e., noise) and may not mitigate bottlenecks in request performances in the cloud environment are not identified. A request map showing one or more threads, each with the sequence of events in order, may be generated and stored in a database (e.g., the database 150, FIG. 1). In an example embodiment, portions of the sequence of events may be stored. In a further example embodiment, the sequence of events may be stored after pre-processing to remove any ID on the events. That is, the sequence of events for the request may be stored in as event patterns. The operation continues to S220 for request performance analysis and optimization for improved resource utilization within the cloud environment (e.g., the cloud environment 110, FIG. 1). It should be noted that request performance analysis and bottleneck identification is performed for identified request.

According to the disclosed embodiments, the trained transformer encoder component recognizes relationships between network events and generated representative vector embeddings to arrange the randomly distributed network events into sequences of events that represent at least a portion of the request. Such generation of sequences facilitate identification of requests without prior knowledge of the request and its events, for example, the starting event. To this end, the trained identification system (e.g., the identification system 130, FIG. 1) may be utilized for various services, applications, and the like, without specific training or modification. Moreover, the identification of continued sequences from the classified clusters may allow conservation of memory (e.g., at identification system 130 and/or database 150, FIG. 1) by eliminating the need to storage every sub-sequence or sequence of events that are otherwise necessary in methods where events of the request need to be matched for identification of requests.

FIG. 4 is an example flow diagram 400 of a two-stage training of a transformer encoder of an identification system according to an embodiment. The transformer encoder is a component of the machine learning models that are deployed in the identification system 130, FIG. 1. The machine learning models may include multiple components including a transformer encoder, a transformer decoder, and a classifier. The training process described herein may be performed within the identification system 130, FIG. 1.

The flow diagram 400 shows a two-stage training approach to perform training of a transformer encoder 410 by a first stage training 401 followed by a second stage training 402. The training is not performed concurrently and the second stage training 402 may be performed intermittently after the first stage training 401. The second stage training 402 may be performed as needed, for example, when applying the transformer encoder for different services. The second training 402 may be further performed with additional labeled training data 152 available for training.

The first stage training 401 is an unsupervised learning that input unlabeled datasets 151 to the transformer encoder 410 to generate vector embeddings 420 of the input datasets. The input datasets 151 include sequences of events that may be at least a portion of different requests of a service. The sequence of events may belong to a single service or to multiple services in the cloud environment. The generated vector embeddings 420 may be input into the transformer decoder 431 which reconstructs the vector embeddings to generate output sequences. The output sequences are compared to input training datasets (input sequences of events) of the transformer encoder to calculate reconstruction losses and to update the transformer encoder 410. The training of the first stage training 401 may be determined to be complete when the reconstruction loss is below a predetermined threshold value, after a predetermined number of training rounds, and the like, and any combination thereof.

The second stage training 402 is a supervised learning that uses labeled training datasets 152. The training datasets 152 that include sequences of events may be labeled as “noise” or “not noise” based on irrelevance or relevance, respectively, to performance optimization. The training dataset 152 includes at least a portion (i.e., sub-sequences) of different request sequences of a service. The second stage training 402 allows fine-tuning of the transformer encoder 410 not only to encode accurately based on semantics, but also to encode efficiently by indicating irrelevance and relevance of events and/or requests from the input data.

The second stage training 402 is performed on the transformer encoder 410 that has been trained through the first stage training 401. The labeled training dataset 152 is input into the first stage trained transformer encoder 410 to generate vector embeddings 420. The vector embeddings 420 are input into a classifier 432 that classifies the output sequence as “noise” or “not noise.” In the second stage training 402, the classifier 432 replaces the transformer decoder 431, of the first stage training 401, to specifically train the transformer encoder 410 to generate vector embeddings 420 that indicate and distinguish events that are irrelevant or relevant (i.e., noise or not noise) for purposes of request performance optimization. Classification losses from the classifier 432 may be returned to update the transformer encoder 410. The training of the second stage training 402 may be determined to be complete when the classification loss is below a second predetermined threshold value, after a second predetermined number of training rounds, and the like, and any combination thereof.

In some implementations, a sufficient training (e.g., first and/or second stage training) of the machine learning models in the identification system (e.g., the identification system 130, FIG. 1) may be checked by the clustered events. The clustered events are examined for accuracy to determine sufficient training of the machine learning models, particularly the transformer encoder, and additional training may be performed if determined to be insufficiently trained. In such implementations, the checking of sufficient training may be performed randomly, intermittently, periodically, purposely, or the like.

In some embodiments, a smaller (or a fewer layer of) transformer decoder may be implemented with respect to the transformer encoder to more effectively train the transformer encoder for accurate encoding of events in the vector embeddings. It should be noted that such configuration of the smaller transformer decoder compared to the transformer encoder induces greater and faster training at the transformer encoder side to reduce losses between the input training datasets and the output sequences from the transformer decoder.

It should be noted that the two-stage training (401 and 402 training) according to the disclosed embodiments allows fine-tuned training of the transformer encoder 410 to generate vector embeddings that accurately understand and represent, for example, position, order, relation, and the like, of unorganized events data that are collected during runtime. That is, the trained transformer encoder 410 is utilized to generate improved vector embeddings that predict relationship and arrangement of events. Particularly, the fine-tuned training using the second stage training 402 trains the transformer encoder 410 to incorporate relevant information of the events. Such generated vector embeddings may be utilized to identify noise events and/or sets of events to be removed from further analyses. It should be further noted that the trained transformer encoder may be utilized to network events monitored and collected at any resources (e.g., the resources 120, FIG. 1) without specific training with respect to the specific resources. However, the second stage training may also be utilized to perform fine-tuned training of the transformer encoder for a specific type of event, resource, and/or service.

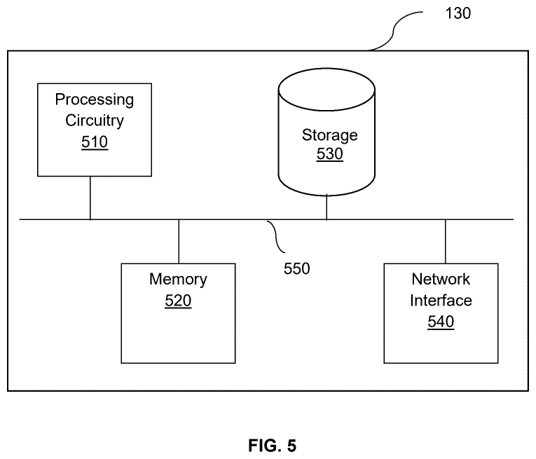

FIG. 5 is an example schematic diagram of an identification system 130 according to an embodiment. The identification system 130 includes a processing circuitry 510 coupled to a memory 520, a storage 530, and a network interface 540. In an embodiment, the components of the identification system 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the identification system 130 to communicate with, for example, the resources 120, the user device 140, the databases (not shown), and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for identifying a request of a service, comprising:
generating vector embeddings for raw data of events using a machine learning model, wherein the machine learning model is trained to indicate semantic meaning of at least one event of the raw data of events;
clustering, based on the vector embeddings, the at least one event of the raw data of events into a plurality of clusters, wherein a subset of the plurality of clusters includes relevant events in the raw data of events; and
identifying a request as a sequence of events from the subset of the plurality of clusters.

2. The method of claim 1, further comprising:
sorting the relevant events based on a plurality of rules that are defined by additional information on each of the relevant events.

3. The method of claim 2, wherein the additional information includes at least one of: timestamp, thread identifier (ID), micro-thread identifier (ID), processor identifier (ID), event type, and file descriptor.

4. The method of claim 1, further comprising:
receiving raw data of events and call stacks that are collected during runtime of a workload, wherein raw data of events include additional information for each event in the raw data of events.

5. The method of claim 1, wherein the raw data of events are collected at predefined intervals.

6. The method of claim 1, wherein the plurality of clusters includes a first hierarchical level of clusters and at least one second hierarchical level of sub-clusters, wherein the subset of the plurality of clusters is a cluster of the first hierarchical level of clusters.

7. The method of claim 1, wherein clustering is performed using at least one of: K-means clustering, Balanced Iterative Reducing and Clustering using Hierarchies (BIRCH), and Ordering Points To Identify the Clustering Structure (OPTICS) clustering.

8. The method of claim 1, further comprising:
determining a start point and an end point using the sequence of events of the identified request; and
determining a request performance.

9. The method of claim 1, wherein training of the machine learning model further comprises:
training the machine learning model based on a reconstruction loss, wherein the reconstruction loss determined by comparing an input sequence of a training dataset to an output sequence; and
fine-tuning the trained machine learning model using a labeled training dataset to indicate the relevant events.

10. A non-transitory computer readable medium having stored thereon instructions for causing a processing circuitry to execute a process, the process comprising:
generating vector embeddings for raw data of events using a machine learning model, wherein the machine learning model is trained to indicate semantic meaning of at least one event of the raw data of events;
clustering, based on the vector embeddings, the at least one event of the raw data of events into a plurality of clusters, wherein a subset of the plurality of clusters includes relevant events in the raw data of events; and
identifying a request as a sequence of events from the subset of the plurality of clusters.

11. A system for identifying a request of a service, comprising:
a processing circuitry; and
a memory, the memory containing instructions that, when executed by the processing circuitry, configure the system to:
generate vector embeddings for raw data of events using a machine learning model, wherein the machine learning model is trained to indicate semantic meaning of at least one event of the raw data of events;
cluster, based on the vector embeddings, the at least one event of the raw data of events into a plurality of clusters, wherein a subset of the plurality of clusters includes relevant events in the raw data of events; and
identify a request as a sequence of events from the subset of the plurality of clusters.

12. The system of claim 11, wherein the system is further configured to:
sort the relevant events based on a plurality of rules that are defined by additional information on each of the relevant events.

13. The system of claim 12, wherein the additional information includes at least one of: timestamp, thread identifier (ID), micro-thread identifier (ID), processor identifier (ID), event type, and file descriptor.

14. The system of claim 11, wherein the system is further configured to:
receive raw data of events and call stacks that are collected during runtime of a workload, wherein raw data of events include additional information for each event in the raw data of events.

15. The system of claim 11, wherein the raw data of events are collected at predefined intervals.

16. The system of claim 11, wherein the plurality of clusters includes a first hierarchical level of clusters and at least one second hierarchical level of sub-clusters, wherein the subset of the plurality of clusters is a cluster of the first hierarchical level of clusters.

17. The system of claim 11, wherein clustering is performed using at least one of: K-means clustering, Balanced Iterative Reducing and Clustering using Hierarchies (BIRCH), and Ordering Points To Identify the Clustering Structure (OPTICS) clustering.

18. The system of claim 11, wherein the system is further configured to:
determine a start point and an end point using the sequence of events of the identified request; and
determine a request performance.

19. The system of claim 11, wherein the system is further configured to:
train the machine learning model based on a reconstruction loss, wherein the reconstruction loss determined by comparing an input sequence of a training dataset to an output sequence; and
fine-tune the trained machine learning model using a labeled training dataset to indicate the relevant events.
